(19) United States
(12) Patent Application Publication
(10) Pub. No.: US 2015/0034544 A1
(43) Pub. Date: Feb. 5, 2015

(54) FILTER STRAW

(71) Applicant: William F. Aftoora, (US)

(72) Inventor: William F. Aftoora, Brunswick, OH (US)

(21) Appl. No.: 14/374,136

(22) PCT Filed: Jan. 18, 2013
(86) PCT No.: PCT/US13/22188

§ 371 Date: Jul. 23, 2014

Related U.S. Application Data
(60) Provisional application No. 61/589,982, filed on Jan. 24, 2012.

(51) Int. Cl. C02F 1/32; C02F 1/28; A47G 21/18; C02F 1/00

(52) U.S. Cl. CPC C02F 1/325; C02F 1/002; C02F 1/283; A47G 21/18; A47G 21/188; C02F 2201/32
USPC 210/251; 239/33

(57) ABSTRACT

A filter straw and kit including a backwashing unit for the filter straw. The filter straw generally includes an elongated housing extending between opposite input and output openings. One or more filtering regions and/or other fluid treating regions may be located within and along a portion of the elongated passageway. The filtering and treating regions include filtering screens, activated carbon filters, silver metal treating regions, and ultraviolet light treating regions.

This application claims the benefit of the filing date under 35 U.S.C. 119(e) of U.S. Provisional Application For Patent Ser. No. 61/589,982 filed Jan. 24, 2012.

### BACKGROUND

Millions of Americans receive high quality drinking water every day from their public water systems. Nonetheless, drinking water safety cannot be taken for granted. There are a number of threats to drinking water: improper disposal of chemicals, animal wastes, pesticides, human wastes, wastes injected deep underground, and naturally-occurring substances can all contaminate drinking water. Likewise, drinking water that is not properly treated or disinfected, or which travels through an improperly maintained distribution system, may also pose health risks.

The U.S. Environmental Protection Agency reports that 90 percent of the world's water is contaminated in some way. There are a variety of microscopic organisms that can contaminate water supplies and cause potentially serious, even fatal, illnesses.

What is needed is a portable, economical and easy to use system for filtering water to remove bacteria, viruses, protozoa, particulates, chemicals and toxins to provide clean, safe and tasty drinking water from a variety of water sources.

### DETAILED DESCRIPTION

The filter straw for drinking liquids includes a first open inlet end and a second open outlet end and a passageway extending between the first open inlet end and the second open outlet end.

According to certain illustrative embodiments, the filter straw comprises a first open inlet end and a second open outlet end and a passageway extending between the first open inlet end and the second open outlet end, and at least one metal or metal alloy filter screen disposed along at least a portion of the elongated passageway extending between the first open input and the second open output.

According to certain illustrative embodiments, the filter straw comprises a first open inlet end and a second open outlet end and a passageway extending between the first open inlet end and the second open outlet end, and at least one cloth micron filter disposed along at least a portion of the elongated passageway extending between the first open input and the second open output.

According to certain illustrative embodiments, the filter straw comprises a first open inlet end and a second open outlet end and a passageway extending between the first open inlet end and the second open outlet end, and a cloth micron filter disposed within the elongated passageway extending between the first open input and the second open output and positioned near the first open intake end and a second cloth micron filter disposed within the elongated passageway extending between the first open input and the second open output and positioned near the second open output end.

According to certain illustrative embodiments, the filter straw comprises a first open inlet end and a second open outlet end and a passageway extending between the first open inlet end and the second open outlet end, and at least one Birm filter disposed along at least a portion of the elongated passageway extending between the first open input and the second open output.

According to certain illustrative embodiments, the filter straw comprises a first open inlet end and a second open outlet end and a passageway extending between the first open inlet end and the second open outlet end, and at least one activated carbon filter disposed along at least a portion of the elongated passageway extending between the first open input and the second open output.

According to certain illustrative embodiments, the filter straw comprises a first open inlet end and a second open outlet end and a passageway extending between the first open inlet end and the second open outlet end, and at least one ultra-violet light region extending along at least of the elongated passageway extending between the first open input and the second open output.

According to certain illustrative embodiments, the filter straw comprises a first open inlet end and a second open outlet end and a passageway extending between the first open inlet end and the second open outlet end, wherein the inner surfaces of at least a portion of the length of the elongated passageway extending between the first open input and the second open output is plated with silver metal.

According to certain illustrative embodiments, the filter straw comprises a first open inlet end and a second open outlet end and a passageway extending between the first open inlet end and the second open outlet end, and wherein the straw further comprises a backwash connection for backwashing and cleaning the filter straw.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, and at least one Birm filter positioned within and along at least a portion of the elongated passageway extending between the first open input and the second open output.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, and at least one cloth micron filter positioned within and along at least a portion of the elongated passageway extending between the first open input and the second open output.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, and a cloth micron filter disposed within the elongated passageway extending between the first open input and the second open output and positioned near the first open intake end and a second cloth micron filter disposed within the elongated passageway extending between the first open input and the second open output and positioned near the second open output end.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, and at least one activated carbon filter positioned within and along at least a portion of the elongated passageway extending between the first open input and the second open output.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, and at least one ultra-violet light region extending along at least of the elongated passageway extending between the first open input and the second open output.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, wherein the inner surfaces of at least a portion of the length of the elongated passageway extending between the first open input and the second open output is plated with silver metal.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, and a backwash connection for backwashing and cleaning the filter straw.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, and at least one cloth micron filter positioned within a portion of the elongated passageway.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, and at least one cloth micron filter positioned within a portion of the elongated passageway near the first open input end and at least one cloth micron positioned within a portion of the elongated passageway near the second open output end.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway, and at least one Birm filter positioned within a portion of the elongated passageway.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway near the first open input end, at least one cloth micron positioned within a portion of the elongated passageway near the second open output end, and at least one Birm filter positioned within a portion of the elongated passageway.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway, and at least one activated carbon filter positioned within a portion of the elongated passageway.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway near the first open input end, at least one cloth micron positioned within a portion of the elongated passageway near the second open output end, and at least one activated carbon filter positioned within a portion of the elongated passageway.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway, wherein the inner surfaces of at least a portion of the length of the elongated passageway extending between the first open input and the second open output is plated with silver metal.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway near the first open input end, at least one cloth micron positioned within a portion of the elongated passageway near the second open output end, wherein the inner surfaces of at least a portion of the length of the elongated passageway extending between the first open input and the second open output is plated with silver metal.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway, and at least one ultra-violet light region extending along at least of the elongated passageway extending between the first open input and the second open output.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway near the first open input end, at least one cloth micron positioned within a portion of the elongated passageway near the second open output end, and at least one ultra-violet light region extending along at least of the elongated passageway extending between the first open input and the second open output.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway, and a backwash connection.

According to certain illustrative embodiments, the filter straw comprises a first open inlet end and a second open outlet end and a passageway extending between the first open inlet end and the second open outlet end, at least one metal or metal alloy filter screen disposed along at least a portion of the elongated passageway extending between the first open input and the second open output, at least one cloth micron filter positioned within a portion of the elongated passageway near the first open input end, at least one cloth micron positioned within a portion of the elongated passageway near the second open output end, and a backwash connection.

According to certain illustrative embodiments, the filter straw comprises a first open inlet end and a second open outlet end and a passageway extending between the first open inlet end and the second open outlet end, at least one cloth micron filter positioned within a portion of the elongated passageway near the first open input end and at least one cloth micron positioned within a portion of the elongated passageway near the second open output end and least one Birm filter.

According to certain illustrative embodiments, the filter straw comprises a first open inlet end and a second open outlet end and a passageway extending between the first open inlet end and the second open outlet end, at least one cloth micron filter positioned within a portion of the elongated passageway near the first open input end, at least one cloth micron positioned within a portion of the elongated passageway near the second open output end, and at least one Birm filter positioned within a portion of the elongated passageway.

According to certain illustrative embodiments, the filter straw comprises a first open inlet end and a second open outlet end and a passageway extending between the first open inlet end and the second open outlet end, at least one cloth micron filter positioned within a portion of the elongated passageway, and at least one activated carbon filter positioned within a portion of the elongated passageway.

According to certain illustrative embodiments, the filter straw comprises a first open inlet end and a second open outlet end and a passageway extending between the first open inlet end and the second open outlet end, at least one cloth micron filter positioned within a portion of the elongated passageway near the first open input end, at least one cloth micron positioned within a portion of the elongated passageway near the second open output end, and at least one activated carbon filter positioned within a portion of the elongated passageway.

According to certain illustrative embodiments, the filter straw comprises a first open inlet end and a second open outlet end and a passageway extending between the first open inlet end and the second open outlet end, at least one cloth micron filter positioned within a portion of the elongated passageway, wherein the inner surfaces of at least a portion of the length of the elongated passageway extending between the first open input and the second open output is plated with silver metal.

According to certain illustrative embodiments, the filter straw comprises a first open inlet end and a second open outlet end and a passageway extending between the first open inlet end and the second open outlet end, at least one cloth micron filter positioned within a portion of the elongated passageway near the first open input end, at least one cloth micron positioned within a portion of the elongated passageway near the second open output end, wherein the inner surfaces of at least a portion of the length of the elongated passageway extending between the first open input and the second open output is plated with silver metal.

According to certain illustrative embodiments, the filter straw comprises a first open inlet end and a second open outlet end and a passageway extending between the first open inlet end and the second open outlet end, at least one cloth micron filter positioned within a portion of the elongated passageway, and at least one ultra-violet light region extending along at least of the elongated passageway extending between the first open input and the second open output.

According to certain illustrative embodiments, the filter straw comprises a first open inlet end and a second open outlet end and a passageway extending between the first open inlet end and the second open outlet end, at least one cloth micron filter positioned within a portion of the elongated passageway near the first open input end, at least one cloth micron positioned within a portion of the elongated passageway near the second open output end, and at least one ultra-violet light region extending along at least of the elongated passageway extending between the first open input and the second open output.

According to certain illustrative embodiments, the filter straw comprises a first open inlet end and a second open outlet end and a passageway extending between the first open inlet end and the second open outlet end, at least one cloth micron filter positioned within a portion of the elongated passageway near the first open input end, at least one cloth micron positioned within a portion of the elongated passageway near the second open output end, and a backwash connection.

According to certain illustrative embodiments, the filter straw comprises a first open inlet end and a second open outlet end and a passageway extending between the first open inlet end and the second open outlet end, at least one birm filter positioned within a portion of the elongated passageway near the first open input end and at least one cloth micron positioned within a portion of the elongated passageway near the second open output end and least one activated carbon filter.

According to certain illustrative embodiments, the filter straw comprises a first open inlet end and a second open outlet end and a passageway extending between the first open inlet end and the second open outlet end, at least one activated filter positioned within a portion of the elongated passageway, wherein the inner surfaces of at least a portion of the length of the elongated passageway extending between the first open input and the second open output is plated with silver metal.

According to certain illustrative embodiments, the filter straw comprises a first open inlet end and a second open outlet end and a passageway extending between the first open inlet end and the second open outlet end, a first activated carbon filter positioned within a portion of the elongated passageway, a second activated carbon filter positioned within a portion of the elongated passageway, and wherein the length of the elongated passageway extending between the first and second activated carbon filters is plated with silver metal.

According to certain illustrative embodiments, the filter straw comprises a first open inlet end and a second open outlet end and a passageway extending between the first open inlet end and the second open outlet end, a first activated carbon filter positioned within a portion of the elongated passageway, and at least one ultra-violet light region extending along at least of the elongated passageway.

According to certain illustrative embodiments, the filter straw comprises a first open inlet end and a second open outlet end and a passageway extending between the first open inlet end and the second open outlet end, a first activated carbon filter positioned within a portion of the elongated passageway, and a second activated carbon filter positioned within a portion of the elongated passageway, and at least one ultra-violet light region extending along at least of the elongated passageway and positioned between the first and second activated carbon filters.

According to certain illustrative embodiments, the filter straw comprises a first open inlet end and a second open outlet end and a passageway extending between the first open inlet end and the second open outlet end, at least one activated carbon filter positioned within a portion of the elongated passageway, at least one cloth micron positioned within a portion of the elongated passageway near the second open output end, and a backwash connection.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one Birm filter positioned within a portion of the elongated passageway, and at least one activated carbon filter positioned within a portion of the elongated passageway.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one Birm filter positioned within a portion of the elongated passageway, and at least one activated carbon filter positioned within a portion of the elongated passageway, and at least one cloth micron positioned within a portion of the elongated passageway near the second open output end.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one Birm filter positioned within a portion of the elongated passageway, at least one activated carbon filter positioned within a portion of the elongated passageway, and at least one region of the passageway coated with silver metal.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one Birm filter positioned within a portion of the elongated passageway, and at least one activated carbon filter positioned within a portion of the elongated passageway, at least one region of the passageway coated with silver metal, and at least one cloth micron positioned within a portion of the elongated passageway near the second open output end.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one Birm filter positioned within a portion of the elongated passageway, at least one activated carbon filter positioned within a portion of the elongated passageway, and at least one region ultraviolet light region.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one Birm filter positioned within a portion of the elongated passageway, and at least one activated carbon filter positioned within a portion of the elongated passageway, at least one region of the passageway coated with silver metal, at least one ultraviolet light region, and at least one cloth micron positioned within a portion of the elongated passageway near the second open output end.

According to certain illustrative embodiments, the filter straw comprises a first open inlet end and a second open outlet end and a passageway extending between the first open inlet end and the second open outlet end, at least one cloth micron filter positioned within a portion of the elongated passageway, and at least one activated carbon filter positioned within a portion of the elongated passageway.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one activated carbon filter positioned within a portion of the elongated passageway, and at least one cloth micron positioned within a portion of the elongated passageway near the second open output end.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one activated carbon filter positioned within a portion of the elongated passageway, and at least one region of the passageway coated with silver metal.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one activated carbon filter positioned within a portion of the elongated passageway, at least one region of the passageway coated with silver metal, and at least one cloth micron positioned within a portion of the elongated passageway near the second open output end.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one activated carbon filter positioned within a portion of the elongated passageway, and at least one ultraviolet light region.

According to certain illustrative embodiments, the filter straw comprises a first open inlet end and a second open outlet end and a passageway extending between the first open inlet end and the second open outlet end, at least one cloth micron filter positioned within a portion of the elongated passageway, a at least one activated carbon filter positioned within a portion of the elongated passageway, at least one region of the passageway coated with silver metal, at least one ultraviolet light region, and at least one cloth micron positioned within a portion of the elongated passageway near the second open output end.

According to certain illustrative embodiments, the filter straw comprises a first open inlet end and a second open outlet end and a passageway extending between the first open inlet end and the second open outlet end, at least one cloth micron filter positioned within a portion of the elongated passageway, and at least one ultraviolet light region.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one ultraviolet light region, and at least one cloth micron positioned within a portion of the elongated passageway near the second open output end.

According to certain illustrative embodiments, the filter straw comprises a first open inlet end and a second open outlet end and a passageway extending between the first open inlet end and the second open outlet end, at least one cloth micron filter positioned within a portion of the elongated passageway, and at least one region of the elongated passageway that is coated with silver metal.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one region of the elongated passageway that is coated with silver metal, and at least one cloth micron positioned within a portion of the elongated passageway near the second open output end.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one region of the elongated passageway that is coated with silver metal, and at least one ultraviolet light treating region.

According to certain illustrative embodiments, the filter straw comprises a first open inlet end and a second open outlet end and a passageway extending between the first open inlet end and the second open outlet end, at least one cloth micron filter positioned within a portion of the elongated passageway, at least one region of the elongated passageway that is coated with silver metal, at least one ultraviolet light treating region, and at least one cloth micron positioned within a portion of the elongated passageway near the second open output end.

The filter straw for drinking liquids includes a first open inlet end and a second open outlet end and a passageway extending between the first open inlet end and the second open outlet end, a metal or metal alloy screen filter positioned at the first open intake end, a first cloth micron filter positioned within the elongated passageway near the first intake end, a Birm filter positioned within the elongated passageway, a first activated carbon filter positioned within the elongated passageway, a region of the elongated passageway having inner surfaces coated with silver metal, an ultraviolet light region, a second activated carbon filter positioned within the elongated passageway, and a second cloth micron filter positioned near the second open output end.

Filter Screen.

The filter straw may include one or more filtering screens positioned at or near the open intake end of the filter straw. According to certain embodiments, a fine mesh filtering screen is positioned at the top of the straw opening to block any coarse material from entering the filter. The filtering screens can efficiently remove particulate matter that could potentially obstruct flow through the finer filter elements. The filter screen or mesh may be manufactured from a metal, a metal alloy, a polymer material, or a composite material. Without limitation, and only by way of illustration, the filtering screen maybe a copper screen filter.

BIRM Filtration Media.

Birm® medium is an efficient and economical media for the reduction of dissolved iron and manganese compounds from raw water supplies. It may be used in either gravity fed or pressurized water treatment systems. Birm® acts as an insoluble catalyst to enhance the reaction between dissolved oxygen (D.O.) and the iron compounds. In ground waters the dissolved iron is usually in the ferrous bicarbonate state due to the excess of free carbon dioxide and is not filterable. Birm®, acting as a catalyst between the oxygen and the soluble iron compounds, enhances the oxidation reaction of Fe++ to Fe+++ and produces ferric hydroxide which precipitates and may be easily filtered. The physical characteristics of Birm® provide an excellent filter media which is easily cleaned by backwashing to remove the precipitant. Birm® is not consumed in the iron removal operation and therefore offers a tremendous economic advantage over many other iron removal methods. Other advantages of Birm® include; long material life with relatively low attrition loss, a wide temperature performance range and extremely high removal efficiency. Negligible labor costs are involved because Birm® does not require chemicals for regeneration, only periodic backwashing is required

Carbon Filter.

Depth Filters use thick porous materials such as carbon or ceramic to trap particles as water flows through the material. Activated carbon filters also remove a range of organic chemicals and heavy metals. Activated carbon filters represent an outstanding material for applications requiring taste, odor and dissolved organic chemical removal from water with suspended matter present. The activated carbon filter may be used for filtering waters having a wide range of pH levels. The large surface area of the activated carbon results in an exceptionally high capacity and efficiency. The balanced pore structure of the activated carbon provides a more efficient adsorbtion range. It is important to note that chlorine, pesticides and organic impurities adhere to the charcoal, which eliminates foul tastes and odors from the drinking water that is drawn into the filter straw.

Silver.

The present filter straw may include one or more regions of the elongated passageway that are plated or otherwise coated with silver metal. Silver ions and silver compounds show a toxic effect on some bacteria, viruses, algae and fungi, typical of heavy metals like lead or mercury, but without the high toxicity to humans that is normally associated with these other metals. Silver is widely known as a broad-spectrum antimicrobial, and its germicidal effects kill many microbial organisms, eliminates or kills forms of microbial life, contained in a fluid. The silver helps to kill or incapacitate bacteria and prevent the growth of mold and algae in the body of the filter. Filter is impregnated with silver and will not permit the growth of bacteria because the silver provides a hostile environment for microbiological organisms. Silver-impregnated inner surfaces to inhibit bacterial growth inside its pores. Silver is known to be an extremely general agent so it can be expected that this device will also work over a wide array of organisms

Ultraviolet Light Region.

The filter straw may also include one or more ultraviolet light treating regions. Ultraviolet light energy in the one or more treating regions maybe used to minimize or eradicate microbiological contamination. Ultraviolight light is light having short waves between x-rays and visible light wavelengths, and which destroys the DNA of microbes in seconds. Without functional DNA, microbes can't reproduce. The ultraviolet light can be used against microorganisms including bacteria and viruses to algae and protozoa. The ultraviolet light is also desirable as it does not impart any foul chemical taste, smell, or side effects. Without limitation, and only by way of illustration, the filter straw includes at least one light-emitting diode capable of emitting ultraviolet light. The ultraviolet light lamp or diode may be provided in any suitable share so long as it can carryout it intended function of minimizing or eradicating microorganisms present in the drinking fluid that is passing through the straw. Without limitation, and only by way of illustration, the ultraviolet lighting emitting lamp or diode may be provided in a tubular or hollow cylindrical shape. The outer tubular ultraviolet light emitting lamp or diode may be provided with an outer circumference which is slightly smaller that the inner circumference of the drinking straw so that the diode or lamp may be positioned at a desired location along the elongated passageway of the drinking straw. The ultraviolet emitting lamp or diode may also be positioned on the outside of the elongated passageway of the drinking straw so long that there is also provided mean by which the ultraviolet light may be able to effectively treat the fluid passing through the drinking straw. The filter straw also includes a power source such as a battery, electrical switches, and electrical circuitry required to operate the ultraviolet light treating region. The power source and electrical switch(es) are in electrical communication via suitable electrical circuitry to operate the ultraviolet light treatment region of the drinking straw.

Backwash.

The filter straw may require periodic backwashing to eliminate accumulated suspended matter and to re-grade the filter bed. The filter straw may be connected to a container containing a source of backwashing fluid. The backwashing may include utilizing a flexible hosing or tubing having connectors attached to opposite ends. One of the connectors is adapted to be connected to a backwash connector on the filter straw. The other of the two connectors of the backwashing tubing is adapted to be connected to the source of the backwashing fluid. To clean the filter, one connector of the backwashing tubing is connected to the backwash connection located on the filter straw. The second connector of the backwashing tubing is connection to the source of the backwashing fluid, which maybe a squeeze bottle containing a sufficient amount of backwashing fluid. The user squeezes the squeeze bottle thereby passing the backwashing fluid quickly upward through the filter straw, opposite the normal direction (called backflushing or backwashing) to remove embedded particles. Quick-connect backwash fittings permit easy installation and removal of input and output hoses. Once the backwashing is completed, the backwashing tubing is disconnected from the filter straw.

The filter straw outer housing may be manufactured from metals, metal alloys, polymer materials, or composite materials. According to certain illustrative embodiments, the filter straw outer housing is manufactured from a polymer material. Without limitation, and only by way of illustration, the filter straw outer housing is manufactured from polyvinyl chloride (PVC).

The filter straw and backwashing apparatus may be provided together as a kit. The it may further include one or more backwashing solutions. The backwashing solutions may be selected from water, bleach, pH increasing agents, and the like. The kit may further include a container, such as a carrying case, for housing the filter straw and the backwashing apparatus. The carrying case may include opening or loops for easy attachment to the clothing or belt of the user.

The bearing structure will now be described in greater detail with reference to the drawing FIGURES. It should be noted that the bearing structure is not intended to be limited to the illustrative embodiments shown in the drawing FIGURES.

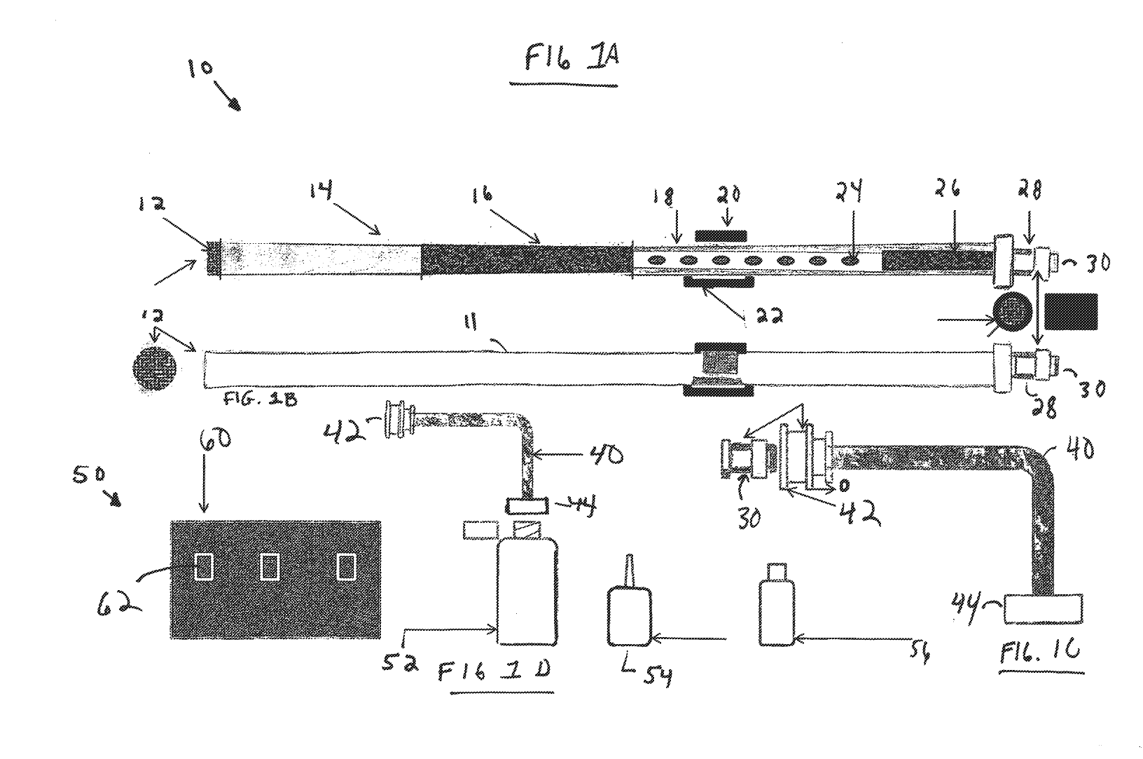

Referring to FIGS. 1A and 1B, an illustrative embodiment of the drinking straw 10 is shown. FIG. 1A shows an elongated drinking straw 10 having a plurality of functional regions for treating a drinking liquid. A first end of the elongated straw 10 includes a metal mesh 12, such as a fine mesh copper screen, covering the inlet opening of the drinking straw 10. A length or section of filtration media 14, such as Birm filtration medium, is position adjacent to the metal mesh screen 12. Regions of activated carbon filtration media 16 and 26 are positioned in-line with Birm filtration medium 14 along the length of the drinking straw 10. A region 18 of the drinking straw 10 that is positioned between the spaced-apart regions of activated carbon 16 and 26 is silver-plated. Region 18 of drinking straw 10 may also include one or more ultra-violet light emitting LEDS 24. The drinking straw 10 includes a power source 22, such as a battery, and an electric switch 20 and electric circuitry for providing power and operating the LEDS 24. The outlet end of the drinking straw 10 includes a connector 28 for connecting a backwashing device. The drinking straw 10 terminates with an outlet sipping orifice or opening 30. FIG. 1B shows the outer sleeve 11 of the drinking straw 10. The outer sleeve 11 maybe manufactured from a wide variety of materials such as, for example, composite materials, paper, polymers, metals, metal alloys, and the like.

Turning to FIG. 1C, tubing 40 having connectors 42, 44 attached to opposites ends is shown. Connector 42 is adapted to be connected to the outlet sipping orifice 40 of the drinking straw 10. Connector 42 may be pulled back in direction D, a portion of orifice 40 inserted, and connector 42 released to engage orifice 40 is a sealing relationship. Connector 44, which is connected to the opposite end of the length of tubing 40 is adapted to be connected to a source of backwashing fluid for backwashing and cleaning the drinking straw 10.

Now referring to FIG. 1D, shows a backwashing kit 50 for backwashing and cleaning drinking straw 10. The kit 50 includes tubing 40 having connectors 42, 44 attached to opposites ends, a source of backwashing fluid in a container 52, a source of cleaning solution in a container 54, and a source of another active agent 56. The active agent may comprise an agent to soften the backwashing fluid or to adjust the pH. All of the components 40, 52, 54, and 56 may be contained within a container 60. The container may comprise a carrying pack 60 that is provided to belt attachment loops 62 to permit the user to easily carry the kit 50 with them. Connector 42 is adapted to be connected to the outlet sipping orifice 40 of the drinking straw 10. Connector 44, which is connected to the opposite end of the length of tubing 40 is adapted to be connected to a source of backwashing fluid for backwashing and cleaning the drinking straw 10. Connector 44 comprises an internally threaded female portion to mate with the externally threaded male portion of the source of backwashing fluid.

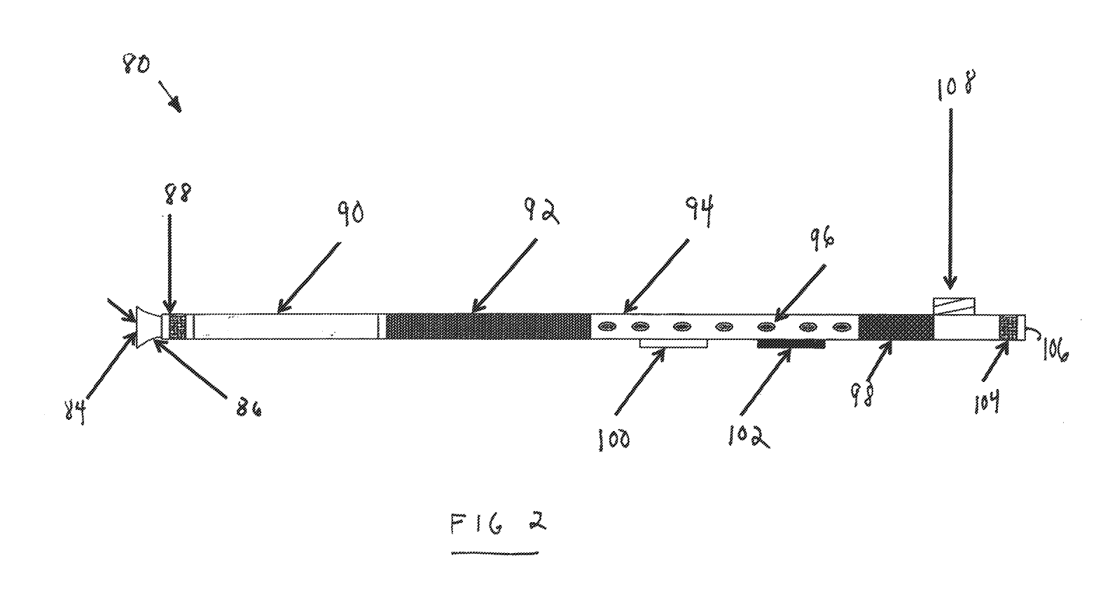

Referring to FIG. 2, another illustrative embodiment of the drinking straw 80 is shown. FIG. 2 shows an elongated drinking straw 80 having a plurality of functional regions for treating a drinking liquid. A first end of the elongated straw 80 includes an inlet orifice 82. Covering at least a portion of the inlet orifice 82 is a metal mesh 84, such as a fine mesh copper screen, covering the inlet opening of the drinking straw 80. The inlet region may comprise a fluted or otherwise tapered metal or metal alloy section 86. Positioned adjacent the fluted region 86 is a cloth micron filter material 88. A length or section of filtration media 90, such as Birm filtration medium, is positioned adjacent to the cloth micron filter 88. Regions of activated carbon filtration media 92 and 98 are positioned in-line with Birm filtration medium 90 along the length of the drinking straw 80. A region 94 of the drinking straw 80 that is positioned between the spaced-apart regions of activated carbon 92 and 98 is silver-plated. Region 94 of drinking straw 80 may also include one or more ultra-violet light emitting LEDS 96. The drinking straw 80 includes a power source 100, such as a battery, and an electric switch 102 and electric circuitry for providing power and operating the LEDS 96. Another amount of cloth micron medium 104 is positioned between the activated carbon filter region 98 and the outlet sipping end 106. A backwash connector 108 emanates outwardly from a surface of drinking straw 80. In the embodiment shown in FIG. 2, the backwash connector 108 comprises an externally threaded male portion that is adapted to be connected to an internally threaded female portion of a source of backwash fluid.

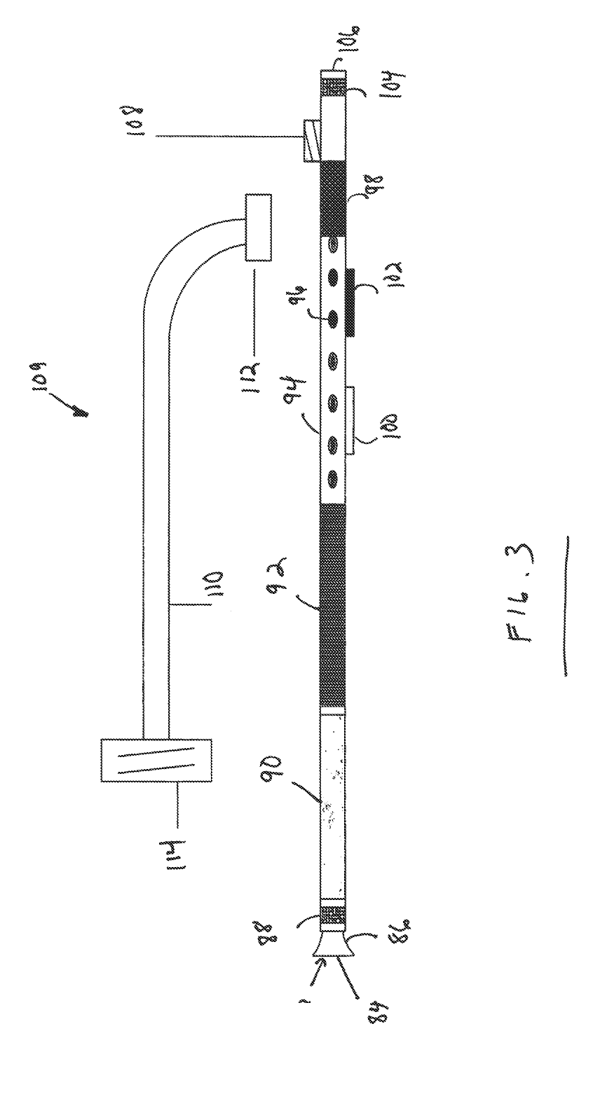

Referring to FIG. 3, another illustrative embodiment of the drinking straw 80 is shown. FIG. 3 shows an elongated drinking straw 80 having a plurality of functional regions for treating a drinking liquid. A first end of the elongated straw 80 includes an inlet orifice 82. Covering at least a portion of the inlet orifice 82 is a metal mesh 84, such as a fine mesh copper screen, covering the inlet opening of the drinking straw 80. The inlet region may comprise a fluted or otherwise tapered metal or metal alloy section 86. Positioned adjacent the fluted region 86 is a cloth micron filter material 88. A length or section of filtration media 90, such as Birm filtration medium, is positioned adjacent to the cloth micron filter 88. Regions of activated carbon filtration media 92 and 98 are positioned in-line with Birm filtration medium 90 along the length of the drinking straw 80. A region 94 of the drinking straw 80 that is positioned between the spaced-apart regions of activated carbon 92 and 98 is silver-plated. Region 94 of drinking straw 80 may also include one or more ultra-violet light emitting LEDS 96. The drinking straw 80 includes a power source 100, such as a battery, and an electric switch 102 and electric circuitry for providing power and operating the LEDS 96. Another amount of cloth micron medium 104 is positioned between the activated carbon filter region 98 and the outlet sipping end 106. A backwash connector 108 emanates outwardly from a surface of drinking straw 80. In the embodiment shown in FIG. 2, the backwash connector 108 comprises an externally threaded male portion that is adapted to be connected to an internally threaded female portion of a source of backwash fluid. Backwashing device 109 includes tubing 110 having connectors 112, 114 attached to opposites ends is shown. Connector 112 is adapted to be connected to the male portion 108 of drinking straw 80. Connector 114, which is connected to the opposite end of the length of tubing 110 is adapted to be connected to a source of backwashing fluid for backwashing and cleaning the drinking straw 80.

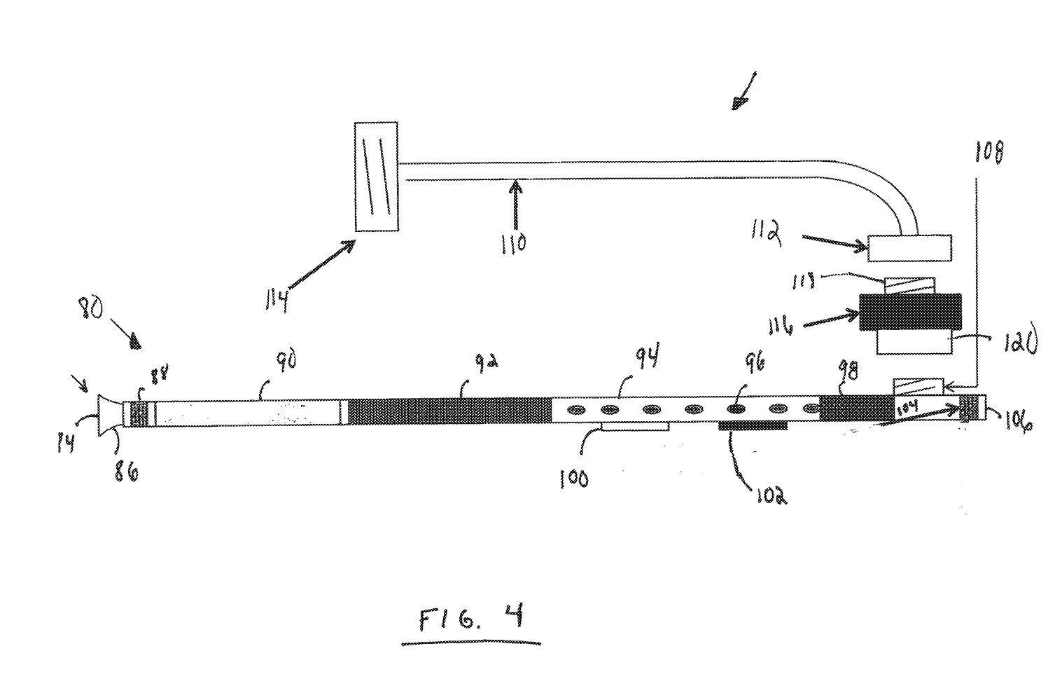

Referring to FIG. 4, another illustrative embodiment of the drinking straw 80 is shown. FIG. 4 shows an elongated drinking straw 80 having a plurality of functional regions for treating a drinking liquid. A first end of the elongated straw 80 includes an inlet orifice 82. Covering at least a portion of the inlet orifice 82 is a metal mesh 84, such as a fine mesh copper screen, covering the inlet opening of the drinking straw 80. The inlet region may comprise a fluted or otherwise tapered metal or metal alloy section 86. Positioned adjacent the fluted region 86 is a cloth micron filter material 88. A length or section of filtration media 90, such as Birm filtration medium, is positioned adjacent to the cloth micron filter 88. Regions of activated carbon filtration media 92 and 98 are positioned in-line with Birm filtration medium 90 along the length of the drinking straw 80. A region 94 of the drinking straw 80 that is positioned between the spaced-apart regions of activated carbon 92 and 98 is silver-plated. Region 94 of drinking straw 80 may also include one or more ultra-violet light emitting LEDS 96. The drinking straw 80 includes a power source 100, such as a battery, and an electric switch 102 and electric circuitry for providing power and operating the LEDS 96. Another amount of cloth micron medium 104 is positioned between the activated carbon filter region 98 and the outlet sipping end 106. A backwash connector 108 emanates outwardly from a surface of drinking straw 80. In the embodiment shown in FIG. 2, the backwash connector 108 comprises an externally threaded male portion that is adapted to be connected to an internally threaded female portion of a source of backwash fluid. Backwashing device 109 includes tubing 110 having connectors 112, 114 attached to opposites ends is shown. Connector 114, which is connected to the opposite end of the length of tubing 110 is adapted to be connected to a source of backwashing fluid for backwashing and cleaning the drinking straw 80. Connector 112 is adapted to be connected to threaded male portion 118 of connector 116. Female portion 120 of connector 116 is adapted to be threadedly connected to male portion 108. Alternatively, female portion 120 may comprise a slip over quick connector.

The filter straw and related methods for using the filter straw not limited to the specific embodiments described above, but includes variations, modifications and equivalent embodiments defined by the following claims. The embodiments described above are not necessarily in the alternative, as various embodiments may be combined to provide the desired characteristics.

1. A reusable drinking straw comprising:
first open inlet end;
a second open outlet end;
an elongated passageway extending between the first open inlet end and the second open outlet end; and
an ultraviolet light treatment region.

2. The drinking straw of claim 1, comprising at least one further treatment region or material selected from the group consisting of a metal screen filter, cloth filter medium, a Birm filter medium, a region of the elongated passageway having inner surfaces coated with silver metal, and combinations of one or more of said treatment regions or material.

3. The drinking straw of claim 2, wherein said at least one further treatment region or material comprises a metal screen filter.

4. The drinking straw of claim 2, wherein said at least one further treatment region or material comprises a cloth filter.

5. The drinking straw of claim 2, wherein said at least one further treatment region or material comprises a Birm filter medium.

6. The drinking straw of claim 2, wherein said at least one further treatment region coated with silver metal.

7. The drinking straw of claim 2, wherein said at least one further treatment region or material comprises a metal screen filter.

8. The drinking straw of claim 2 wherein said at least one further treatment region comprises a metal screen filter and cloth filter medium.

9. The drinking straw of claim 2 wherein said at least one further treatment region comprises a metal screen filter, cloth filter medium, and a Birm filtration medium.

10. The drinking straw of claim 2 wherein said at least one further treatment region comprises a metal screen filter, cloth filter medium, a Birm filtration medium, and a region coated with silver metal.

11. A reusable drinking straw comprising:
first open inlet end;
a second open outlet end;
an elongated passageway extending between the first open inlet end and the second open outlet end; and
a washing device in fluid connection with said straw.

12. The drinking straw of claim 12, wherein said straw includes a fluid treatment region or material.

13. The drinking straw of claim 13, wherein said fluid treatment region comprises an ultraviolet light treatment region.

14. The reusable drinking straw of claim 13, wherein said straw comprises at least one treatment region or material selected from the group consisting of a metal screen filter, cloth micron filter medium, a Birm filter medium, a region of the elongated passageway having inner surfaces coated with silver metal, and an ultraviolet light region and combinations of one or more of said treatment regions or material.

15. The drinking straw of claim 14, wherein said at least one further treatment region or material comprises a metal screen filter.

16. The drinking straw of claim 14, wherein said at least one further treatment region or material comprises a cloth filter.

17. The drinking straw of claim 14, wherein said at least one further treatment region or material comprises a Birm filter medium.

18. The drinking straw of claim 47, wherein said at least one further treatment region coated with silver metal.

19. The drinking straw of claim 14, wherein said at least one further treatment region or material comprises a metal screen filter.

20. The drinking straw of claim 14 wherein said at least one further treatment region comprises a metal screen filter and cloth filter medium.

21. The drinking straw of claim 14 wherein said at least one further treatment region comprises a metal screen filter, cloth filter medium, and a Birm filtration medium.

22. The drinking straw of claim 14 wherein said at least one further treatment region comprises a metal screen filter, cloth filter medium, a Birm filtration medium, and a region coated with silver metal.

23. A kit comprising:
at least one drinking straw comprising:
first open inlet end;
a second open outlet end; and
an elongated passageway extending between the first open inlet end and the second open outlet end;
a washing device for said straw said straw; and
a source of washing fluid.

24. The kit of claim 23, wherein said straw includes a fluid treatment region comprising an ultraviolet light treatment region.

25. The kit of claim 24, wherein said straw comprises at least one further treatment region or material selected from the group consisting of a metal screen filter, cloth micron filter medium, a Birm filter medium, a region of the elongated passageway having inner surfaces coated with silver metal, and combinations of one or more of said treatment regions or material.
